(19) United States
(12) Patent Application Publication
(10) Pub. No.: US 2016/0224995 A1
(43) Pub. Date: Aug. 4, 2016

(54) DELTA-BASED SIMULATION SYSTEMS

(71) Applicant: TRADING TECHNOLOGIES INTERNATIONAL, INC., CHICAGO, IL (US)

(72) Inventor: Bevan BROOKFIELD, Evanston, IL (US)

(21) Appl. No.: 14/985,543

(22) Filed: Dec. 31, 2015

Related U.S. Application Data
(60) Provisional application No. 62/110,186, filed on Jan. 30, 2015.

(51) Int. Cl. G06Q 30/02; G06Q 40/04

(52) U.S. Cl. CPC G06Q 30/0201; G06Q 40/04

(57) ABSTRACT

This patent document disclosed and describes a system and method to provide a simulation on a trading. An example method includes receiving a first electronic market data from a stored data source; receiving a first simulated trade action for a first tradable object; executing the first simulated trade action for the first tradable object with respect to the first market data, such that the execution of the first simulated trade action generates second market data based on an impact of the first simulated trade action on the first market data; determining a first delta between the first market data and the second market data, such that the first delta reflects a difference between the first market data and the second market data.

### CROSS REFERENCE TO RELATED APPLICATIONS

This application claims priority to U.S. Provisional Application No. 62/110,186 filed Jan. 30, 2015, which is hereby incorporated by reference in its entirety.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

The trading device may provide a trading interface to enable a user to monitor the information about the market and execute trades via the electronic exchange. Some trading interfaces dynamically list prices, bid quantities and/or ask quantities of a tradable object to enable the user to determine a market depth of the tradable object. Any mechanism to provide a review of trading activity may rely on static reports and manual setup.

### BRIEF DESCRIPTION OF THE FIGURES

Exemplary embodiments are disclosed with reference to the following drawings.

FIG. 1 illustrates a block diagram representative of an example electronic trading system in which embodiments may be employed.

FIG. 2 illustrates a block diagram of another example electronic trading system in which embodiments may be employed.

FIG. 3 illustrates a block diagram of an exemplary computing device that may be used to implement the disclosed embodiments.

FIGS. 4A-C illustrate evolution of a book of orders and quotes for an example instrument during simulation.

FIG. 5 illustrates a flow diagram of an exemplary method for providing a recorded market data feed for simulation of trading activity in a production electronic trading system.

FIGS. 6A-C illustrate an example trading interface with recorded market data in a simulation of one or more tradable objects.

FIG. 7 illustrates a flow diagram of an exemplary method to record, report, and/or analyze a trading simulation using recorded market data in an electronic trading system

FIG. 8 illustrates a flow diagram of an exemplary method to facilitate a simulation of trading activity and/or normal trading activity in a production electronic trading system.

FIG. 9 depicts an exemplary trading system configured to provide simulation or replay of recorded and/or other non-live market data and/or execution of trades via an exchange in a “normal” or regular trading mode.

FIG. 10 illustrates an exemplary replay or simulation system configured from a trading system used in regular trading of tradable objects on an exchange.

FIG. 11 shows an exemplary replay interface configured to launch and control a trading simulation or replay.

FIG. 12 illustrates an exemplary audit interface provided in conjunction with replay simulation of one or more trading instruments.

Embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosure relates generally to data distribution systems, and more particularly, to systems and methods to simulate and replay actual trading activity in a simulated environment.

Trading devices may be configured to monitor a market for a tradable object, execute trades of the tradable object and/or perform other actions. The electronic exchange communicates market data to the trading device. The trading device stores, organizes, analyzes and/or displays the market data. As the tradable object is traded on the market, the price of the tradable object may move or change (e.g., increase, decrease, fluctuate, etc.).

Market data may be replayed, such as to back test systems, algorithms, and/or trading strategies. Prior attempts to create a test system involve a significant manual setup effort. Prior attempts to create a test system also can only be run on separate, dedicated equipment located on the premises and may be used at times when no ‘real’ and/or real-time activity is occurring in the trading facility. Such systems reduced usefulness and effectiveness of any such test system, while also excluding users not located on the premises in a multi-tenant application service provider (ASP) system.

Prior testing environments required significant expense and/or significant operational restrictions. Setup and configuration of the prior testing environments are often manual, where a new testing environment needed to be created. New testing environments often remained idle when not being used until the environment need to be used. Where the testing environment was based off a production environment, the testing environment could only be used during off hours, or non-trading hours. Great caution also had to be employed when converting back from a testing environment to production to minimize a risk for production trading. In addition, the conversion back to the production system configuration needed to be performed in a timely.

Availability of back test data also can be difficult. In prior approaches, a user must be able to record the data and remember to do so for periods that were desired for replay. Alternatively, the user must systematically record such data, resulting in a significant burden in machine power during the production day, as well as significant consumption of storage (e.g., memory and/or disk) space. Administering such a repository, managing space consumption, archive and discard policies, etc., becomes burdensome, time-consuming, inefficient, and costly. Additionally, such prior manual systems are ineffective in simulating custom trading algorithms, such as those that can be created using graphical interface tools (e.g., ADL® provided by Trading Technologies International, Inc. of Chicago, Ill. (“Trading Technologies”)).

In contrast, exemplary embodiments provide widespread, systematic back/replay testing of tradable objects and trading strategies, including custom algorithms. Exemplary simulator systems that may be set up at any time with minor configuration, may be used at any time, may be charged for by use and/or support replay against standard processes in a trading system stack such as an algorithmic trading server, pre-trade risk, credit risk, ledger and position servers, etc. Examples provide stored market data and accurately simulate real markets using a replay of market data to drive that simulation.

Exemplary replay systems run on a virtual machine, such as a virtual machine in a server farm. The exemplary replay system may utilize standard production versions of trading system components except for a modified market data server, which is modified to accept replay instructions and replay public market data from file or other market data history source.

Exemplary systems and methods may test coding and selection of trade instrument(s) and/or other tradable object(s) for validity and likelihood of success based on prior, recorded market data executed in a production trading environment configured for simulation. As simulation execution continues, examples provide a modified simulation price feed. The modified simulation price feed may adjust the recorded market data price feed based on an effect simulation trade activity is having on the recorded market.

Although examples including, among other components, software executed on hardware, are disclosed, it is noted that the examples are merely illustrative and should are not considered as limiting. For example, it is contemplated that any or all of the hardware and software components may be embodied exclusively in hardware, exclusively in software, exclusively in firmware, or in any combination of hardware, software, and/or firmware. Accordingly, embodiments may be implemented in other ways.

Additionally, while some examples described herein may refer to functions performed by one or more given actors such as “users” and/or other entities, it should be understood that this is for purposes of explanation only. The claims should not be interpreted to require action by any such example actor unless explicitly required by the language of the claims themselves.

### I. Brief Description of Exemplary Embodiments

Exemplary embodiments include a system that includes a simulator having a processor and a memory. The processor is configured to execute instructions stored in the memory to receive first market data from a stored data source. The processor also or alternatively is configured to execute instructions stored in the memory to receive a first simulated trade action for a first tradable object. The processor also or alternatively is configured to execute instructions stored in the memory to execute the first simulated trade action for the first tradable object with respect to the first market data. The execution of the first simulated trade action generates second market data. The second market data may be generated, for example, based on an impact of the first simulated trade action on the first market data. The processor also or alternatively is configured to execute instructions stored in the memory to determine a first delta between the first market data and the second market data. The first delta reflects a difference between the first market data and the second market data. The processor also or alternatively is configured to execute instructions stored in the memory to receive a second simulated trade action; and execute the second simulated trade action with respect to the second market data to generate third market data. The processor also or alternatively is configured to execute instructions stored in the memory to provide the third market data for simulated trading.

Exemplary embodiments also include a method to provide a simulation on a trading system. The exemplary method may be carried out, for example, by an electronic processor of an electronic trading device in communication with an electronic exchange for electronically communicating messages and executing operations responsive to those messages. The method includes receiving first market data from a stored data source. The method also or alternatively includes receiving a first simulated trade action for a first tradable object. The method also or alternatively includes executing the first simulated trade action for the first tradable object with respect to the first market data. The execution of the first simulated trade action is to generate second market data based on an impact of the first simulated trade action on the first market data. The method includes determining a first delta between the first market data and the second market data. The first delta reflects a difference between the first market data and the second market data. The method also or alternatively includes receiving a second simulated trade action. The method also or alternatively includes executing the second simulated trade action with respect to the second market data to generate third market data. The method also or alternatively includes providing the third market data for simulated trading.

Exemplary embodiments also include a tangible computer readable storage medium having instructions stored thereon. The exemplary instructions, when executed, cause an electronic computing device to at least implement a simulation on a trading system, including receiving first market data from a stored data source exemplary instructions and a first simulated trade action for a first tradable object. The exemplary instructions, when executed, cause the computing device to execute the first simulated trade action for the first tradable object with respect to the first market data. The execution of the first simulated trade action generates second market data based on an impact of the first simulated trade action on the first market data. The exemplary instructions, when executed, also or alternatively cause the computing device to determine a first delta between the first market data and the second market data, which reflects a difference between the first market data and the second market data. The exemplary instructions, when executed, also or alternatively cause a computing device to receive a second simulated trade action and execute the second simulated trade action with respect to the second market data to generate third market data. The exemplary instructions, when executed, cause a computing device to provide the third market data for simulated trading.

### II. Example Electronic Trading System

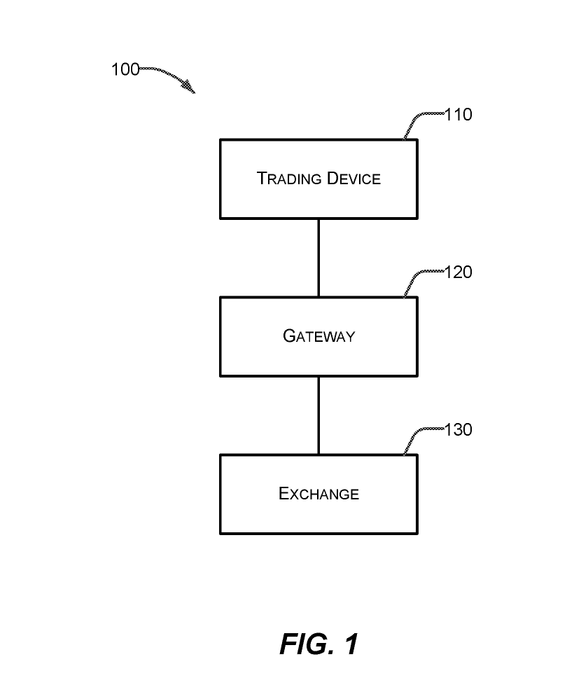

FIG. 1 illustrates a block diagram representative of an exemplary electronic trading system 100 in which exemplary embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication. The communications may be through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. The trading device 110 may be used, for example, to monitor the market data and/or for a determination as to whether to send an order message, such as a message to trade (e.g. buy or sell) one or more tradable objects to the exchange 130.

Market data may include data representing market for a tradable object. For example, market data may include at least any one of the inside market, market depth, last traded price (“LTP”), a last traded quantity (“LTQ”), and/or a combinations thereof. The inside market refers to the highest available bid price (best bid) and the lowest available ask price (best ask or best offer) in the market for the tradable object at a particular point in time (since the inside market may vary over time). That is, the best bid and/or the best offer may vary over time, and as such, the inside market varies over time accordingly. Market depth refers to quantities available in the market. For example, the market depth includes the quantity at various price levels including the inside market and away from the inside market. Market depth may have “gaps” such as a price level with no quantity available in the market.

The price levels associated with the inside market and market depth may be provided as value levels such as the price of the tradable object. The price level also or alternatively may be provided with value levels that are derived and/or calculated representations of value. For example, value levels may be displayed as net change from an opening price. As another or additional example, value levels may be provided as a value calculated from prices in two other markets. In another example, value levels may include consolidated price levels.

A tradable object is anything that may be traded at a price for a quantity. For example, a quantity of the tradable object may be bought and/or sold at a price. Tradable objects include, for example, financial products, stocks, options, bonds, future contracts, currency, warrants, funds derivatives, securities, commodities, swaps, interest rate products, index-based products, traded events, goods, and/or a combinations thereof. A tradable object may include real tradable objects such as a product listed and/or administered by an exchange, a synthetic such as user-defined product, a combination of real or synthetic products, and/or combinations thereof. A synthetic tradable object also may correspond and/or is similar to a real tradable object.

An order message is a message that includes a trade order. A trade order may be, for example, a command to place an order to buy or sell a tradable object; a command to initiate managing orders according to a defined trading strategy; a command to change, modify, or cancel an order; an instruction to an electronic exchange relating to an order; and/or combinations thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, and/or combinations thereof. As another example, the trading device 110 includes a single or multi-core processor in communication with a memory or other storage medium. The processor may be configured to accessibly store one or more computer programs, applications, libraries, computer readable instructions, and the like, for execution by the processor.

As used herein, the phrases “configured to” and “adapted to” represent an element, structure, or device has been modified, arranged, changed, and/or varied to perform a specific function or for a specific purpose.

By way of example, the trading device 110 is implemented as a computing device running a copy of X_TRADER®, an electronic trading platform provided by Trading Technologies. As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use.

The trading device 110 may include one or more trading applications. As used herein, a trading application is an application that facilitates or improves electronic trading. A trading application provides one or more electronic trading tools. For example, a trading application stored by a trading device may be executed to receive, arrange and display market data in one or more trading windows. In another example, a trading application may include an automated spread trading application for administering spread trading tools. In yet another example, a trading application may include an algorithmic trading application that automatically processes an algorithm and performs actions, such as placing an order, modifying an existing order, and/or deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110, such as from another computer readable medium. For example, the trading application (or updates to the trading application) may be stored by a manufacturer, developer, or publisher of the trading application onto one or more CDs or DVDs, which are then loaded onto the trading device 110 or to a server from which the trading device 110 retrieves the trading application. As another example, the trading device 110 may receive the trading application (or updates to the trading application) from a server, for example, via the Internet and/or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment that does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof

The gateway 120 may facilitate communication. For example, the gateway 120 may perform protocol translation for data communicated between the trading device 110 and the exchange 130. The gateway 120 may process an order message received from the trading device 110 into a data format understood by the exchange 130. Similarly, the gateway 120 may transform market data in an exchange-specific format received from the exchange 130 into a format understood by the trading device 110.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, and/or combinations thereof.

In exemplary embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies.

The exchange 130 may be owned, operated, controlled, or used by a third-party entity, such as one or more exchanges of the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold at the exchange. The exchange 130 may include separate entities, some of which list and/or administer tradable objects and others which receive and match orders. The exchange 130 may include an electronic communication network (“ECN”).

In an example, the exchange 130 is an electronic exchange adapted to receive electronic order messages for trade orders and to match contra-side trade orders to buy and sell tradable objects. Unmatched trade orders may be listed for trading by the exchange 130, such as in an order book maintained by the electronic exchange for the tradable object. Once an order to buy or sell a tradable object is received and confirmed by the exchange, the order is considered to be a working order until it is filled or cancelled. Where only a portion of the quantity of the order is matched, the matched quantity is removed from the order book and the partially filled order remains a working order. The trade orders may include trade orders received from the trading device 110 or other devices in communication with the exchange 130. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed, such as to subscribing devices including the trading device 110, gateway 120 data repositories, and data redistributors. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

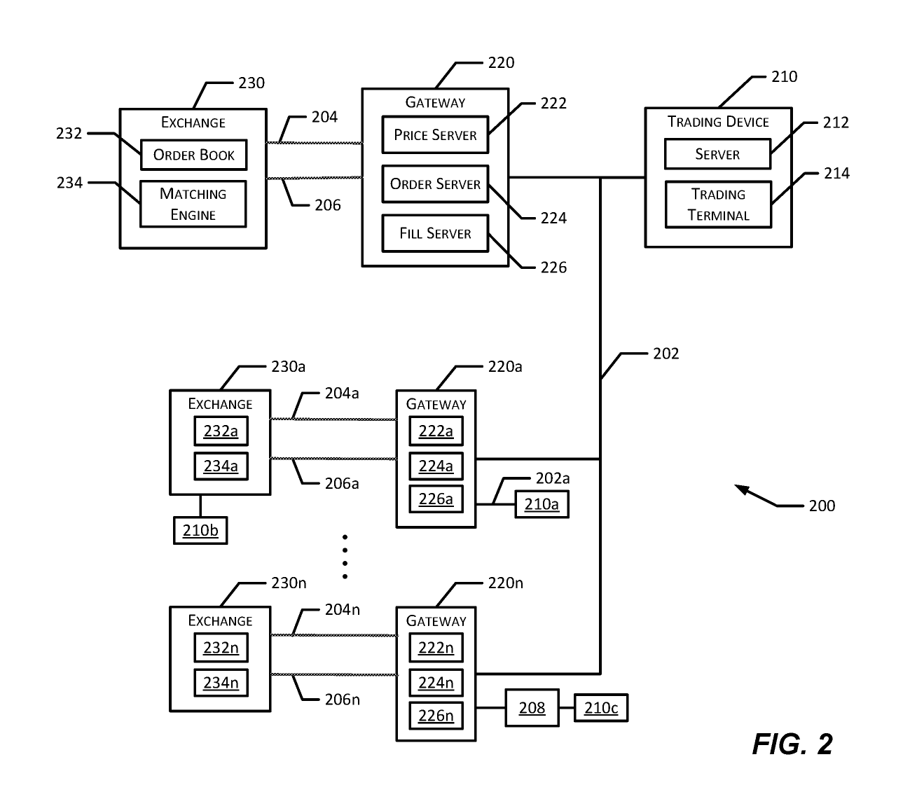

FIG. 2 illustrates a block diagram of another exemplary electronic trading system 200 in which embodiments may be employed. In this example, a trading device 210 utilizes one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. Though shown for simplicity and efficiency, there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located more proximate to the gateway 220 than the trading terminal 214, such as to reduce latency and/or communication delays. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradable objects. The order server 224 processes order data. Order data represents information related to a user's trade orders. For example, order data may include order messages, confirmation messages, and/or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In exemplary embodiments, the additional gateways 220a-220n each include instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price. In exemplary embodiments, the additional exchanges 230a-230n each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In exemplary embodiments, the gateway 220 is part of the trading device 210. For example, the components of the gateway 220 may be part of the same computing platform as the trading device 210. As another example, the functionality of the gateway 220 may be performed by components of the trading device 210. In exemplary embodiments, the gateway 220 is not present. Such an arrangement may occur, for example, when the trading device 210 does not need to utilize the gateway 220 to communicate with the exchange 230, such as when the trading device 210 has been adapted to communicate directly with the exchange 230 and/or via another intermediary device.

### IV. Exemplary Computing Device

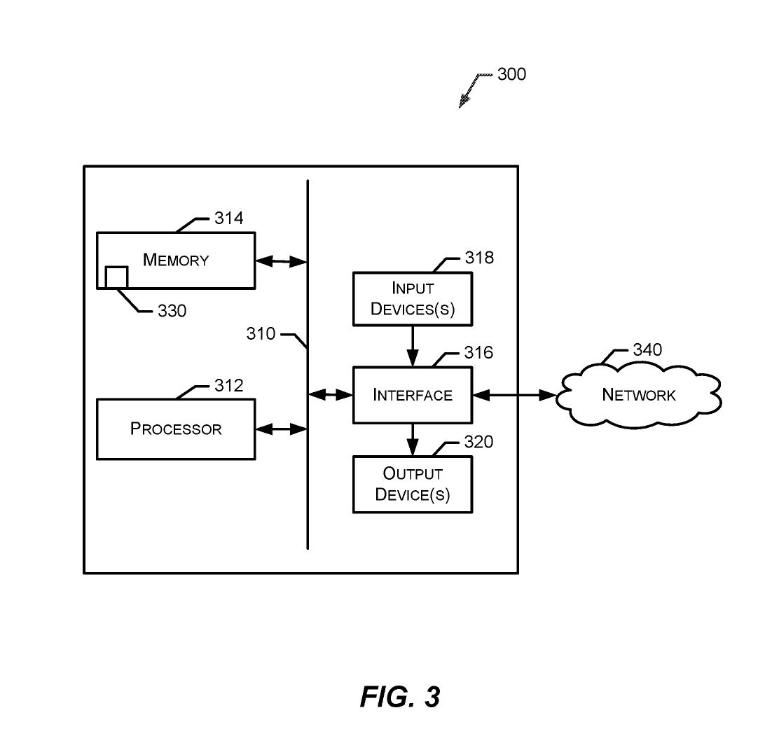

FIG. 3 illustrates a block diagram of an exemplary computing device 300 that may implement the disclosed embodiments. The trading device 110 of FIG. 1 may include one or more computing devices 300. The gateway 120 of FIG. 1 may include one or more computing devices 300. The exchange 130 of FIG. 1 may include one or more computing devices 300.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In exemplary embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions that may be executable by the processor 312 or a different processor. The logic may be stored as part of software, hardware, integrated circuits, firmware, and/or micro-code. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, and/or combinations thereof. The memory 314 may be adjacent to, part of, programmed with, networked with, and/or remote from processor 312. The data stored in the memory 314 may be retrieved and processed by the processor 312. The memory 314 may store instructions which are executable by the processor 312. The instructions may be executed to perform one or more of the acts or functions described herein or shown in the figures.

The memory 314 may store a trading application 330. In exemplary embodiments, the trading application 330 may be accessed from or stored in different locations. The processor 312 may access the trading application 330 stored in the memory 314 and execute computer-readable instructions included in the trading application 330.

In exemplary embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Exemplary Trading Simulation Systems and Methods

Exemplary improved simulation systems and methods utilizing production systems, real trading settings, and real trading data are provided. The examples facilitate dynamic, “real time” trading simulation that tracks and maintains an effect of simulated trades with respect to underlying recorded market data.

Example Simulation with Liquidity Reduction

Exemplary embodiments provide more accurate simulated trading of one or more tradable objects by tracking liquidity reduction continuously in a simulated market. The simulated trading facilitates large-scale, network-based (e.g., cloud-based) trading replay and simulation applying one or more trading strategies from one or more traders to real, recorded market data to monitor, record, analyze, and compare resulting impact on the market and its liquidity.

Market data may be organized according to a plurality of levels (or price tiers), the depth and/or detail of market data. For example, each successive level (e.g., level one, level two, level three, etc.) may include values that indicate more detail or additional information regarding the market data beyond the detail provided at prior levels. In an example, Data also or alternatively may be partitioned into multiple levels for update, simulation, etc.

In some examples, the data levels are organized in descending levels of interest (e.g., a first level of data includes most requested data, and a second level includes second most requested data, etc.). Additionally or alternatively, each data level may represent a level of information detail. Each data level is partitionable or may be separated from the data levels below. That is, data is ordered into levels or tiers such that recipients may specify a preference to receive only a subset of the levels, beginning with a first data level and cumulatively through a preferred data level. For example, some recipients may prefer to receive the first three data levels while other recipients may prefer to receive only the first data level. Some recipients may desire only information in the fifth data level, for example, but, in accordance with the partitionable data levels technique, such recipients are willing to also receive levels above their desired data level (in this example, levels one through four). Examples also include embodiments where each data level may include multiple data values.

Prior market simulation that administered test trading against a “real” market (either live or recorded) modeled a market based on market data and allowing users to place orders “against” that market, where the orders may trade if market conditions allow. An approach would use only level one data (e.g., a first level of market depth or detail) and allow the user to place an order that either trades immediately in full if marketable, or rests and then trades if the market moves. Order size is not considered, nor is impact on market liquidity (e.g., impact of a successfully executed order on ease of filling other present orders, future orders, etc.).

Other approaches model an entire market depth and user orders within that depth, with an estimation of an order's place in a queue at the order's price tier in the market. When orders are placed that cross the market (e.g., bid prices exceed ask prices), rules of an exchange being modeled (e.g., first-in first-out (FIFO) (e.g., price and time are used as criteria to fill an order), Pro-Rata (e.g., fill orders according to price, order size, and time), Pro-Rata with priority (e.g., Pro-Rata but the first incoming order that betters the market gets priority), etc.) are used to remove liquidity from the simulation market, and user orders may then get partially or fully filled.

However, even when the market is correctly modeled in full depth in such simulations, once there is a quote update, any liquidity removed by simulated trading is replaced at the end of time priority queues. Thus, effect on liquidity from trades in the prior simulation systems is not realistic because the effect is gone as soon as an update is received. Using such simulations, it is impossible to accurately simulate liquidity replacement that may result if the trade had actually happened in the real market, but some replacement is likely. For example, iceberg orders (e.g., a large order divided into multiple smaller parts such that only a portion of the order is visible at a time) or algorithmic trades (e.g., electronic trading via an algorithm that executes pre-programmed trading instructions based on one or more variables including timing, price and/or order quantity, also referred to as “algo” trading or black-box trading) may refresh some of that liquidity, and/or other traders may react to the trade prints by placing new orders.

Additionally, it is not realistic in an open-ended simulation to keep track of liquidity reduction resulting from simulated trading and to continuously re-apply the liquidity reduction over the market depth data. However, running some trading algorithms or trading strategies in a simulator may give inaccurate results due to the overoptimistic approach of allowing liquidity to refresh as soon as the market depth quote refreshes. Permanently reducing the liquidity is a better approach, even if, as noted above, it does not model the liquidity replacement that may happen in a real market.

Delta-Based Replay Tracking

For back test scenarios in which a separate machine is used to go back and test or replay trading scenarios on recorded market data, a duration or lifespan of the test and associated market simulation is of limited closed ended duration, and only a single user is allowed. In such a configuration, the market may be simulated using continuous liquidity reduction. In contrast, examples provide back testing or replay of one or more trading scenarios by one or more users in a market simulation that facilitates ongoing liquidity reduction, rather than refresh or replacement, using a determined delta formed with respect to the recorded market data.

Examples include recorded market data may be provided to a simulation running in a regular production trading environment having one more trading devices and order servers using a snapshot of that market data. As the simulation progresses, changes to that recorded market data caused by trading of one or more tradable objects in the simulation may be tracked with respect to the original market data snapshot using deltas. Examples of delta, snapshot, and “deltasnap” information techniques may be found in pending application Ser. No. 14/329,602, filed on Jul. 11, 2014, assigned to Trading Technologies International, Inc., which is herein incorporated by reference in its entirety.

A delta represents a difference between states of data. For example, a delta may be a difference between a most recent previous state of a data source and a current state of the data source. A delta also or alternatively may be a difference between current state of the data source and a known or recorded state of the data source at a prior point in time. Accordingly, a current state of the data source at a time t may be determined as illustrated in Equation (1):

Current State(t)=S_{R}+Δ₁+Δ₂+ . . . +Δₜ Eq. (1),

where S_{R} represents a snapshot of the data source (e.g., recorded market data) taken prior to time t, and Δ₁ through Δₜ each represent a delta at a point in time since that most recent snapshot. Thus, market data may be recorded and used for simulation. Changes to the market due to trade orders executed in simulation may be reflected, for example, as deltas with respect to a recorded data snapshot.

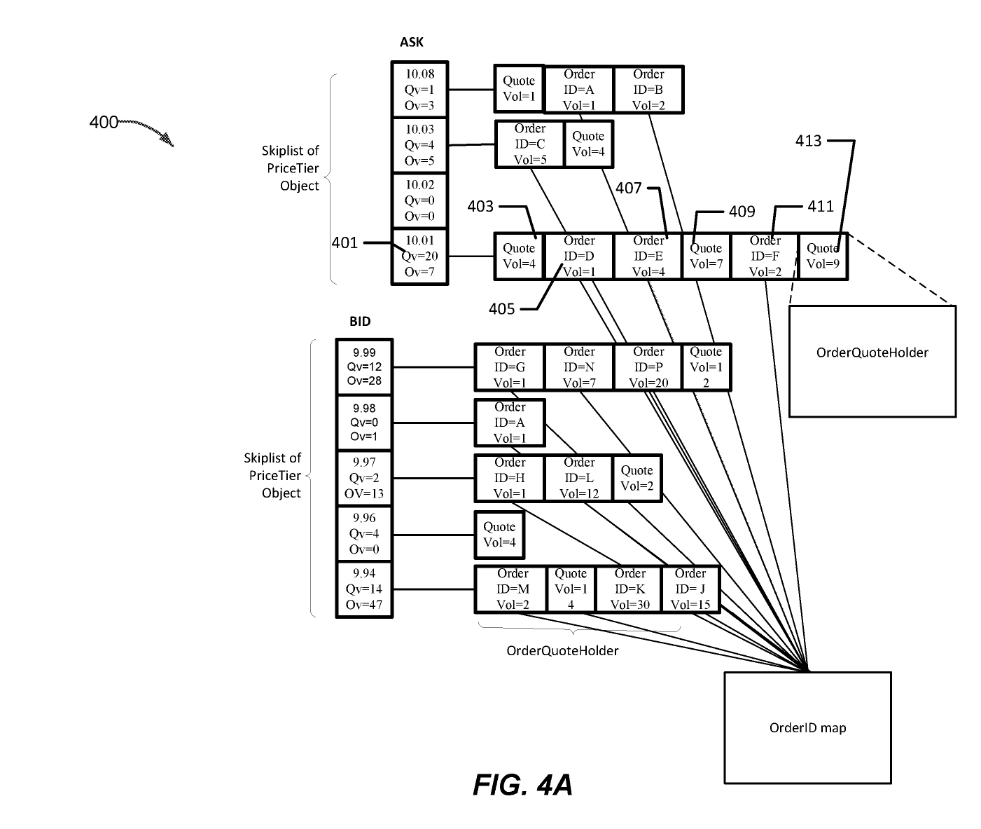

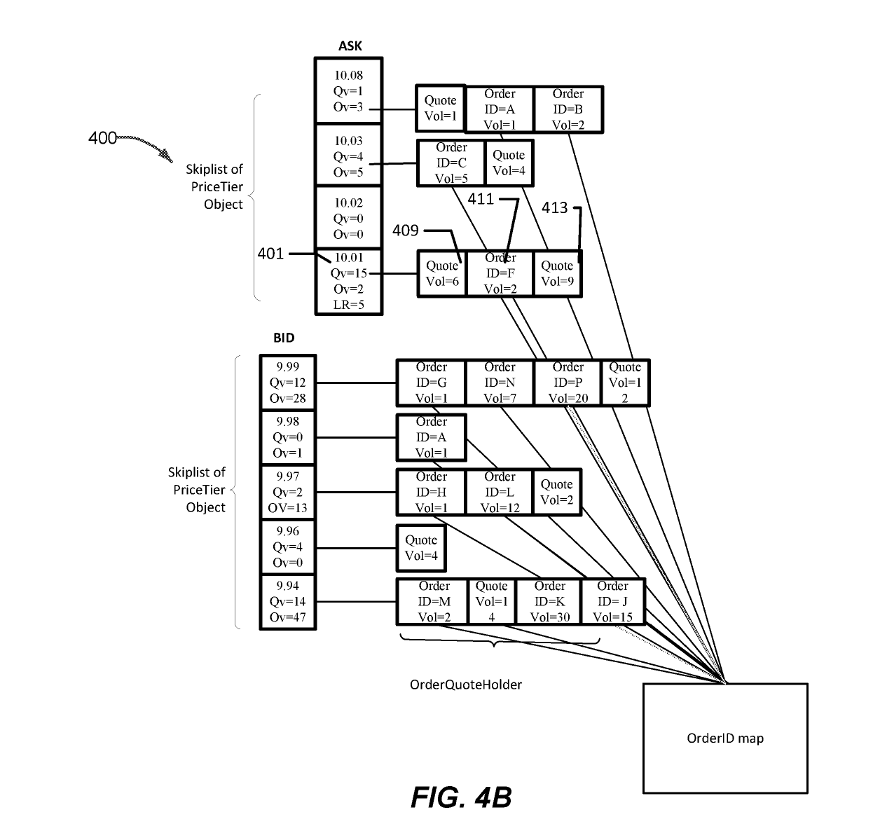

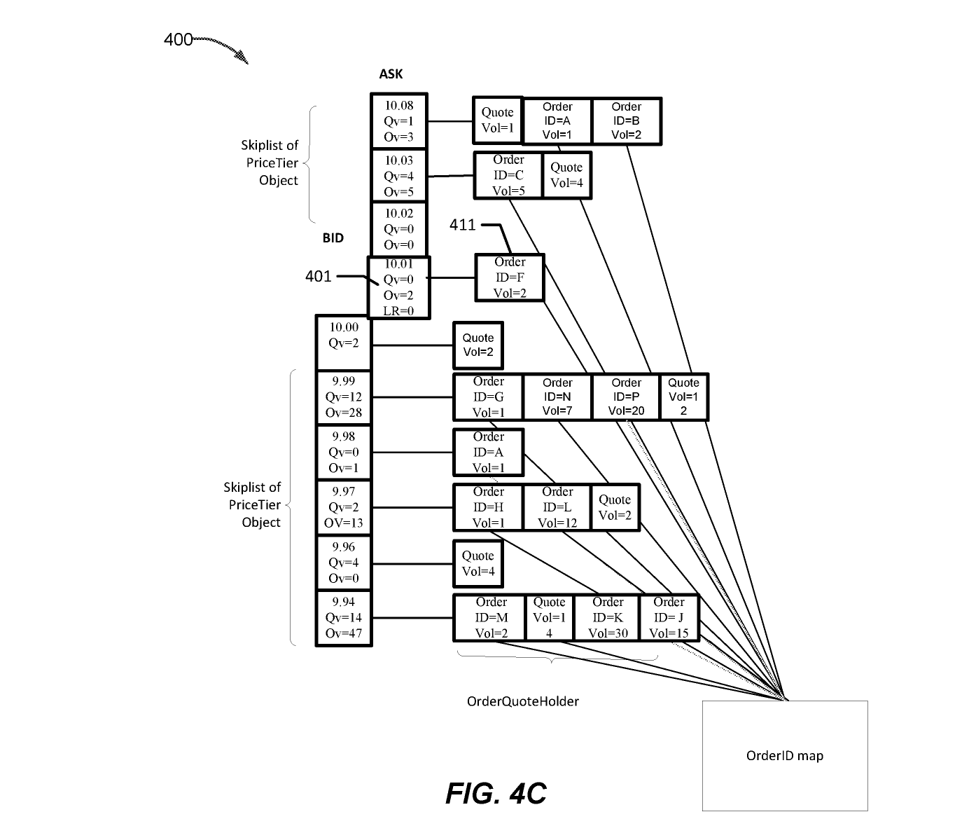

FIGS. 4A-C shows an exemplary order book 400 for a tradable object being traded in simulation. The order book 400 includes multiple price tiers. The order book 400 also shows data from a simulated trading market interlaced with real data for a market for a tradable object. Quotes may be considered the messages to trade the tradable object received via the real data, or market data. Orders may be considered the messages to trade the tradable object received from via a simulated trading environment. The quotes are in the real market and the orders are not in the market. Quotes and/or orders are reflected in the exemplary order book 400 at respective tiers for the price of the order and quote. For each price tier, quotes and orders are queued by respective time of arrival at the price tier. Where a time a quote is received at a price tier at the electronic exchange is not provided in the real market data from the electronic exchange, time of arrival of the quote at the price tier is estimated. As such, FIGS. 4A-C shows an estimated sequence for when the order/quote was received at a price tier. An increase in volume at a price tier due to an order increasing the volume at the price tier is recorded at the end of the queue. A decrease in volume due to a trade is apportioned according to rules of the simulated exchange (e.g., at the beginning for a FIFO market). A decrease in volume without a trade is also recorded at the end of the queue for the price tier.

When an order is placed that trades a tradable object and removes liquidity at a price tier, quotes or orders are reduced or removed in order according to the rules of the exchange for the tradable object. At the next quote update in the real market data, an available volume for that particular price tier may be re-quoted to be same as the available volume was before the trade order. In an open-ended simulation, the re-quote would therefore add liquidity at the end of the queue.

In a closed ended simulation, liquidity for each tier may be tracked. For example, a reduction in liquidity may be tracked for each tier, and, on requote, the quoted value is reduced by that reduction in liquidity (to a minimum of zero). Changes in effective tier volume is processed as before (e.g., adds go to the end, reductions are from quotes in the queue already traversing end to start, etc.). Liquidity reduction may be recorded or stored as a single value (e.g., a delta) at each price tier. The liquidity reduction remains in effect until the simulation ends. Liquidity reduction is subtracted from the underlying market quote (e.g., the recoded market data).

In FIG. 4A, the market for the tradable object includes a price tier 401 having a value of 10.01, a quote volume (Qᵥ) of twenty (20) for the underlying market quotes, and an order volume (Oᵥ) of seven (7) from the simulated (SIM) orders. As such, at price tier 401 has a resting volume of twenty-seven (27) (e.g., (Qᵥ+Oᵥ). In a simulation environment, the resting volume is shown to a user in a trading interface (e.g., a window in a graphical trading application such as MD TRADER®, X-TRADER®, etc., provided by Trading Technologies). The price tier 401 includes a leading quote 403 for a volume of four (4), order 405 for a volume of one (1), 407 for a volume of four (4), a quote 409 for a volume of seven (7), an order 411 for a volume of two (2), and a quote 413 for a quantity of nine (9). The leading quote may be considered a quote at the front of a queue for the price tier. In a FIFO system, the leading quote may be executed before other quotes at the price tier.

FIG. 4B further illustrates the exemplary order book 400 where an order to buy a quantity of ten (10) at a price of 10.01 has been received in a FIFO market. As shown, the price tier 400 has been modified to reflect the changes with respect to FIG. 4A due to the order to buy a quantity of ten (10) at the price tier of 10.01. The leading quote 403 for a volume of four (4), order 405 for one (1) and order 407 for four (4) have been removed as the buy order for ten (10) would be matched against at least quote 403 and orders 405 and 407. In addition, the buy order of ten (10) would also be matched with one (1) of quote 409. As such, FIG. 4B shows quote 409 reduced from seven (7) in FIG. 4A to a quantity of six (6). FIG. 4B also shows that the price tier 401 has a quote volume (Qᵥ) of fifteen (15) and an order volume (Oᵥ) of two (2). In the simulation environment, the volume at price tier 401 would appear as seventeen (17) via the trading interface. The identification “LR” indicates the liquidity reduced or liquidity reduction for the price level. As shown in FIG. 4B, the value for volume that was reduced, or the liquidity reduced (LR), at the price level is 5. The value for LR indicates a volume at the price tier that has been removed from the actual market data for the price tier. That is, the market data at the price tier was reduced by 5.

The liquidity reduction LR for the price tier may be recorded or otherwise stored. In an example where the underlying market quote is subsequently refreshed and unchanged (e.g., at a volume of twenty (20)). The prior liquidity reduction in quote volume of five (5) that is recorded is taken into account with the refreshed data for the price tier. Thus, the effective volume is fifteen (20−5=15), and the refresh of data does not add or remove anything from the price tier 401.

Where a subsequent refreshed quote volume at a price tier reduces to the same volume as the value of the reduction in volume as determined by the liquidity reduction and there are no orders at the price tier (e.g., no SIIM orders), that price tier is shown as empty. Because the price tier may be shown as empty, the market may be considered to have been widened Where a subsequent refreshed quote volume at a price tier reduces below the liquidity reduction value and there are no SIM orders, that tier becomes empty, the liquidity reduction value is (LR) reduced to be no larger than the new quoted volume. Again, the market may be considered to be widened.

In an example where the market simulation as shown in FIG. 4B moves and the underlying market quote 401 at 10.01 becomes zero (0), liquidity reduction is removed, (e.g., becomes zero (0)), and only the order 411 for a volume of two (2) remains at the price tier. As shown in the example of FIG. 4C only order 411 for a volume of 2 remains at price tier 401. Actions, such as a transitions in exchange state from open to closed, (e.g., the market closes at the end of a trading day) clear the liquidity reduction values. For example, liquidity reduction is cleared by a quoted volume dropping to zero at all price tiers.

Liquidity reduction may be considered a property of a user-specific central limit order book (CLOB) model. Where the user has no orders placed, that CLOB is subject to timeout and removal. Placing an order later recreates the CLOB without issue, but the liquidity reduction values are lost. As such, examples include a configuration of a back-test system image that uses longer timeouts to preserve liquidity reduction values.

As illustrated in FIGS. 4A-4C, a quoted volume for a price tier from a recorded market data feed may be augmented to display a simulated volume to a user. Orders generated from a simulation environment may be added to the quoted volume at the price tier. In addition, a delta from the quoted volume, or a liquidity reduction, may be tracked or recorded according to matching of orders and/or quotes at the price tier. Such augmenting of the quoted volume allows trading activity to occur consistently in simulation, rather than be reset upon a subsequent market data update. Display of recorded market data may be modified by the delta value or liquidity reduction, which, may change as further trades are made to modify the simulated market with respect to the recorded market data.

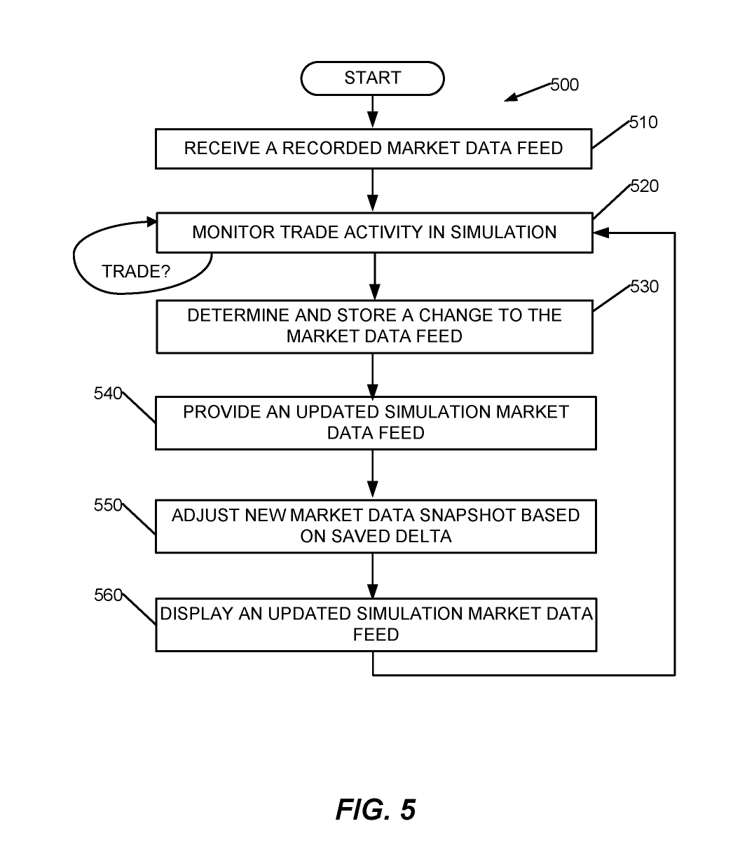

FIG. 5 illustrates a flow diagram of an exemplary method 500 to provide a recorded market data feed for simulation of trading activity in a production electronic trading system (e.g., the electronic trading system 100, 200). The trading system 100, 200 may be configured, in whole or in part, to execute simulated trades, rather than actual trades. The simulated trades may be executed for a period of time (e.g., while in a simulation mode or state). Once switched to an active trading state, rather than a simulation state, the trading system 100, 200 may be used to communicate order messages for tradable objects with an electronic exchange. In the simulation mode, the trading system 100, 200 utilizes components of the active trading environment (e.g., trading device 210, gateway or order server 220, data feeds, etc.), operating instead on a recorded data feed with a simulated exchange server such that actual orders are not actually communicated with an electronic exchange as live trades with respect to real time market data.

At block 510, a market data feed is received from a stored data source. For example, data representing a period of recorded market data from an exchange (e.g., a day's trading recorded from an exchange server, etc.) is received in a trading environment. Market data may be recorded for a period of time, such as during a day's live trading. The market data may be recorded, logged, saved, tracked, or otherwise stored by a trading device, a gateway, an order server, a simulation server, etc. Market data may include “real” or actual trading data that is saved for later simulation for one or more tradable objects. In an example, audit and/or log data recorded during a day's trading session may be used for its intended auditing, logging, or reporting purpose and also be routed as a simulation data feed. Using recorded market data representing actual activity in a market, increased realism is provided in the simulation. Additionally, the simulation may be sped up or slowed down with respect to the recorded market data.

A period of recorded market data may be provided as a market snapshot such as a recorded market data snapshot from one or more exchanges. The recorded market data snapshot is used as the simulation market data feed. The recorded market data snapshot may be used, for example, to drive trade activity with respect to one or more tradable objects in the simulation.

At block 520, trade activity is monitored to identify changes to the recorded market data. For example, as trading progresses in the simulation, a result of a trade order is compared against the simulation market data feed to identify an impact of the trade order on the market data.

At block 530, changes to the recorded market data feed used in the simulation are determined and stored as deltas with respect to the snapshot. For example, where an executed trade order results in a change in the simulation to the simulation market data feed snapshot, then that difference is determined and stored as a delta with respect to the saved market data feed snapshot. For example, where ten (10) units of a tradable object X are taken out of the market in simulation on the trading system, then a delta of minus ten (−10) of tradable object X is computed and saved. In an example, recorded market data is provided as a snapshot with delta(s) with respect to the snapshot. The simulation delta can then be applied on top of the recorded market data feed delta to maintain data integrity within the simulation.

At block 540, a market data feed update is provided within the simulation by applying the delta to the recorded market data feed snapshot. For example, the computed delta is applied to the stored market data feed snapshot to provide an updated simulation market data feed. For example, a delta of minus ten (−10) for tradable object X is applied to a market data feed snapshot quantity of fourteen (14) for tradable object X. Applying the delta to the stored snapshot value provides a simulation market data feed value of fourteen minus ten equals four (14−10=4).

At block 550, a new snapshot of recorded market data is adjusted. The new snapshot of the recorded market data may be adjusted, for example, by a most recent delta from the previous snapshot. For example, where a subsequent market data feed recording is provided in an additional snapshot (e.g., after an elapsed period of time, a simulation server provides an updated market data feed recording), the stored delta(s) are applied to that updated snapshot. By applying delta to the updated snapshot, an effect of trade activity in the simulation may be maintained rather than being reset or reduced by a stored market data update.

In an example, the new snapshot of market data indicates a quantity of fifteen (15) of tradable object X and a prior simulation would reset the quantity of tradable object X to fifteen. The delta of minus ten may be applied such that the simulation quantity of tradable object X is fifteen minus ten equals five (15−10=5). Thus, an additional quantity of one (1) has been added to the simulation market data, and the effect of the trade for ten units has been maintained for consistency and realism in the simulation on the production trading system.

At block 560, market data may be provide, such as via a trading interface display. In addition, the market data is made available for simulated trading as updated through application of any deltas to the recorded market data feed snapshot. For example, a display is provided to a trader (e.g., via a trading interface running on a trading device such as trading device 210) showing an inside market and/or other market data in simulation based on the recorded market data feed. The snapshot of recorded market data is adjusted in the simulation using the delta to reflect an effect of trade activity within the simulation that did not occur on the actual market (and is therefore not reflected in the recorded data snapshot). By applying the delta to the snapshot, continued integrity and consistency may be preserved in the simulation while not contaminating the market data recording.

The visual display of updated simulation market data may be facilitated by augmenting and/or replacing the recorded data feed snapshot with a simulation data feed resulting from the application of the delta to the snapshot. Alternatively or in addition, a result of the delta on the snapshot may be overlaid on the recorded market data feed. The overlay may cover the underlying market data feed snapshot or may be displayed in conjunction with the original recording of market data such that the trader can appreciate a change caused by the trade activity.

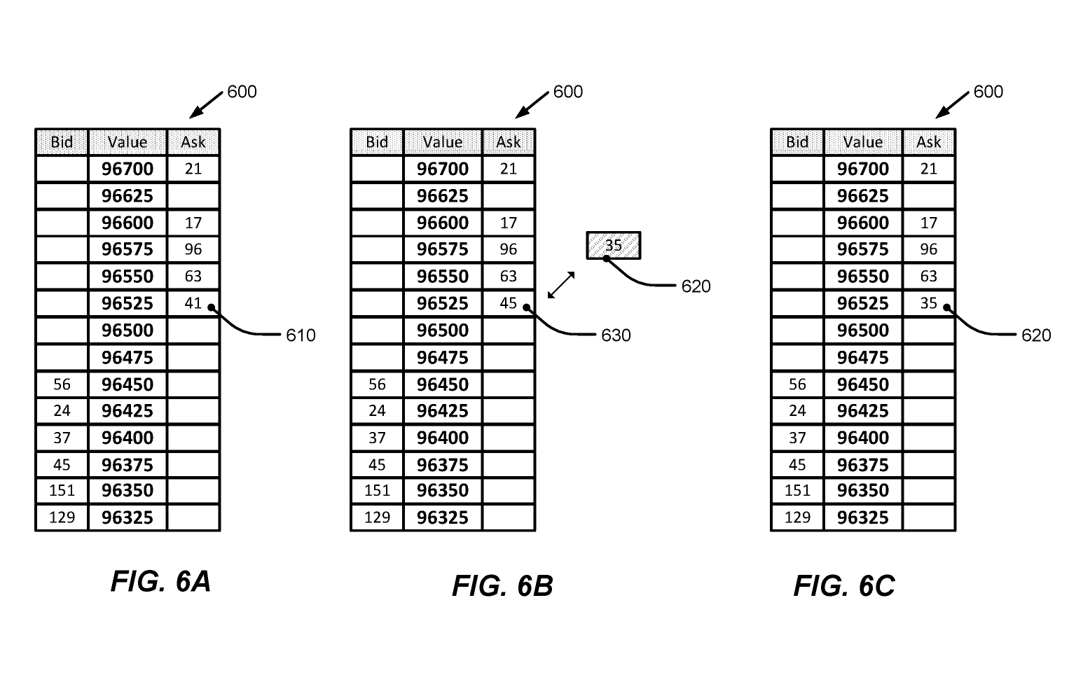

FIG. 6A depicts an example trading interface 600 showing recorded market data in a simulation of one or more tradable objects. The trading interface 600 includes a bid column, a value column, and an ask column. FIG. 6B illustrates the example trading interface 600 including a delta overlay 620, depicting a delta introduced through simulation of trading activity with respect to a recording of market data. FIG. 6C shows a result of the overlay in updated market data via the trading interface 600.

For example, the trading interface 600 of FIG. 6A shows an ask quantity at 610 of forty-one (41). A trade within the simulation executes a purchase of ten (10) of the quantity of forty-one so that a quantity of thirty-one (31) would remain at that asking price. Subsequently, a market update of stored data is received and indicates that the quantity at the asking price is forty-five (45). Rather than resetting the value in the simulation to forty-five (and thereby wiping out an effect of the simulated trade), the updated quantity of forty-five is adjusted based on the previously determined delta. Here, the delta represents the quantity of ten of the tradable object that was previously purchased at the asking price. Applying the delta of ten to the new quantity of forty-five provides an updated simulation value of forty-five minus ten equals thirty-five (45−10=35). As illustrated in FIG. 6B, a delta overlay 620 shows a value of thirty-five, adjusted for simulation, rather than the recorded data feed value 630 of forty-five. As shown in the example trading interface of FIG. 6C, once the simulation delta overlay 620 has been applied to an impacted value 630 in the interface 600, the user sees a correctly adjusted value within the context of the simulation. Thus, a user in the simulation operates as if a quantity of thirty-five is available at the given price, rather than the reset quantity of forty-five, and change in liquidity and simulation flow are preserved in the context of the simulation of trading.

As described with respect to FIG. 5, examples operate with respect to a recorded market data feed provided to the trading system in simulation mode. Thus, rather than live streaming market data, a recorded set of previously streamed actual market data is stored and used to facilitate simulation as if trading activity were taking place in a live exchange environment. Simulation trading outcomes on the trading system can similarly be recorded, stored, and provided to one or more simulation participants to facilitate analytics, data mining, auditing, etc.

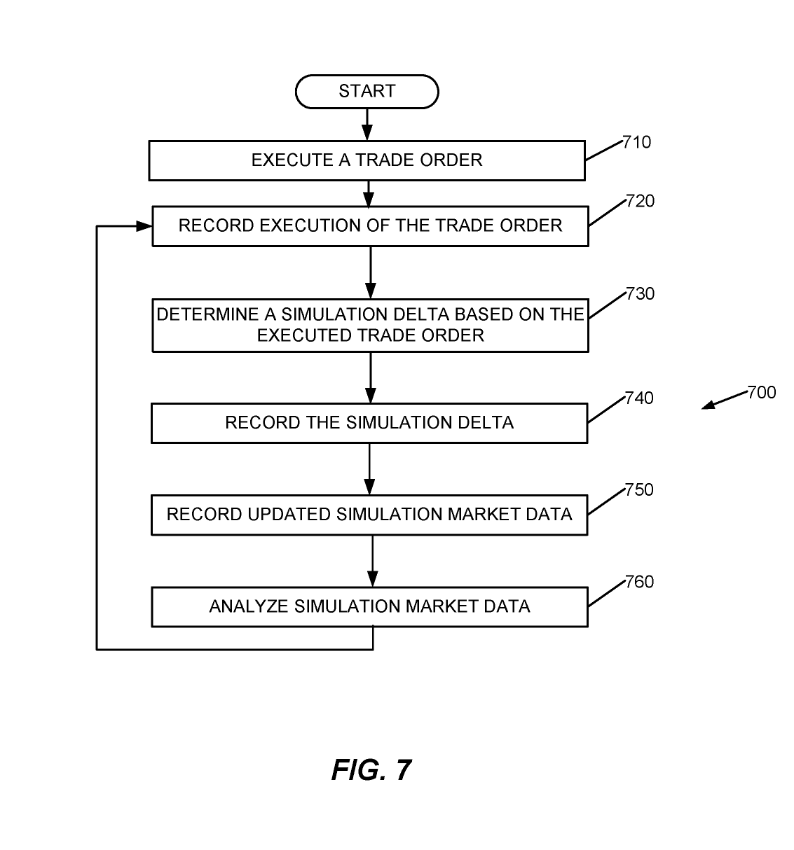

FIG. 7 illustrates a flow diagram of an exemplary method 700 to record, report, and/or analyzes a trading simulation using recorded market data in an electronic trading system (e.g., electronic trading system 100, 200). While the trading system is configured, in whole or in part, to execute simulated trades rather than actual trades (e.g., while the electronic trading system 100, 200 is running in a simulation mode or state), simulated trading activity executed using real trade instruments operating on a recording of an actual market data feed is recorded and stored for logging, auditing, reporting, and/or playback.

At block 710, a trade order is executed. For example, an order to buy a tradable object is filled resulting in a quantity of the tradable object being taken out of or removed from the market (and thereby reduce liquidity in the market). For example, an order for a tradable object Y at a quantity of five (5) and a price of one (1) is executed at the trading device in simulation mode with respect to simulation market data formed from a previously recorded market data snapshot stored for the trading system to create the simulation environment.

At block 720, the execution of the trade order is recorded. For example, the trading activity is recorded within the simulation for analysis, playback, reporting, etc. Recorded trading activity data may be used to modify the previously recorded market data snapshot and/or recorded market data feed delta. In an example, a feed of simulation trading data may be provided to one or more actors such as an algorithmic trading server (also referred to as an algo server), edge server, trading device, etc., (e.g., to inform the actor that its trade has been executed and the like).

At block 730, a delta is determined (e.g., generated, updated, etc.) based on an impact of the executed trade order on the recorded market data snapshot. For example, where five (5) units of a tradable object Y are taken out of the market at a price of one (1) in simulation on the trading system, then a delta of minus 5 (−5) of tradable object Y is computed and saved, tracked, logged or otherwise stored so that is may be retrieved at a later time. In an example, recorded market data is provided as both a snapshot and additional delta(s) with respect to the snapshot and/or with respect to other deltas. The simulation delta may be applied on top of or augment the market data feed delta to maintain data integrity within the simulation.

At block 740, the delta is recorded. For example, as with the simulation trading activity, delta information is recorded to be applied to a trading interface within the simulation as well as for analysis, playback, reporting, etc. A recorded delta is used to modify the previously recorded market data snapshot and/or recorded market data feed delta. In an example, a feed of simulation delta information may be provided to one or more actors such as an algorithmic trading server (also referred to as an algo server), edge server, trading device, etc., (e.g., to inform the actor that its trade has been executed and the like).

At block 750, updated simulation market data is recorded. For example, a market data feed update is provided within the simulation by applying the simulation delta to the recorded market data feed snapshot. The computed simulation market delta may be applied to the stored market data feed snapshot to provide an updated simulation market data feed. For example, where delta is determined to be minus 5 (−5) for tradable object Y and is applied to a market data feed snapshot quantity of ten (10) for tradable object Y to provide a simulation market data feed value of ten minus five equals five (10−5=5).

By applying the computed simulation delta to the updated market data snapshot, an effect of trade activity in the simulation may be maintained rather than being reset or reduced by a stored market data update. The simulation data (e.g., the computed simulation delta) may be stored as market data for the simulation and/or may be stored separately from the recorded market data feed to then be applied to the recorded market data to provide simulation data. By applying the simulation delta to the previously recorded exchange market data, continued integrity and consistency may be preserved in the simulation while not contaminating the market data recording.

At block 760, simulation market data is analyzed. In an example, the recorded simulation data (e.g., including the market data feed recording as well as the trading activity delta from within the simulation) is analyzed to evaluate trading of one or more tradable objects in the simulation. For example, effectiveness, reliability, risk, success/failure, etc., of a trading algorithm and/or other trading strategy may be analyzed and evaluated based on the recorded simulation data (e.g., a comparison of the simulation delta to the baseline market data feed recording). Analytics and/or other data mining may be provided in a spreadsheet, database, graph, chart, table, heat map, tag cloud, etc. Results may be provided to one or more stakeholders (e.g., a trader, a group of traders, an exchange, a broker, algo developer, media, etc.).

In an example, an impact and/or import of results can also be provided. For example, an indication that a trading algorithm and/or other trading strategy from the simulation should be modified may be provided based on an analysis of the results. In an example, Best practices, investment guidance, etc., also or alternatively may be generated based on simulation results. In an example, A risk rating, reliability rating, and/or difficulty rating, etc., may be also or alternatively may generated based on the simulation results. Such ratings may be used in conjunction with a trader's profile (e.g., including experience, role, etc.) to supervise and/or otherwise manage the trader's trading activity (e.g., risk management, etc.).

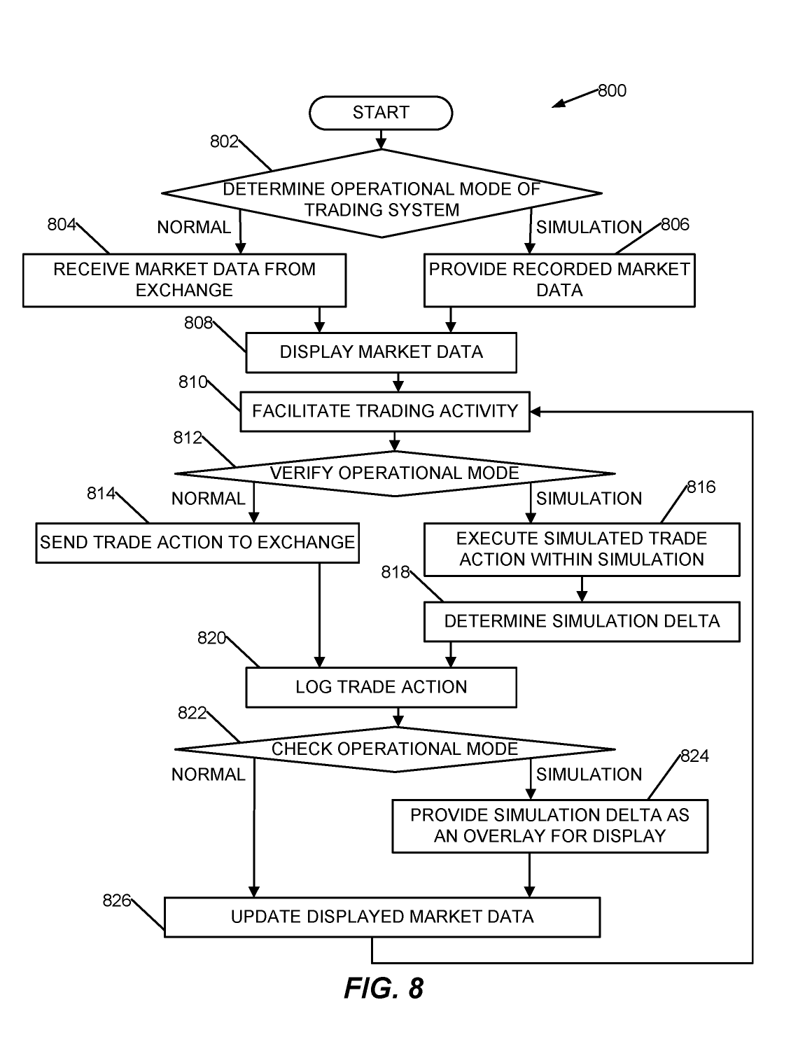

Examples also may facilitate realistic trading simulation with an actual exchange market data feed that has been recorded during a prior trading period (e.g., so as to enable use of an actual trading system with actual trading data without corrupting or otherwise interfering with normal (e.g., non-simulation) trading operations). FIG. 8 illustrates a flow diagram of an exemplary method 800 to facilitate a simulation of trading activity and/or normal trading activity in a production electronic trading system.

At block 802, an operational mode of a trading system is determined. For example, the trading system (e.g., exemplary trading system 100, 200, etc.) can operate in a normal trading mode or a simulation mode. Identifying the mode of operation dictates how the trading system is used. For example, a virtual machine (“VM”) running an image of a production trading system may operate for normal trading with an exchange. The VM running an image of a production trading system also or alternatively can operate for simulated trading with previously recorded or otherwise saved data. For example, a trader triggers a simulation control, selects a simulation option, etc., to initiate the simulation mode (rather than an active or normal trading mode) on a trading device (e.g., trading device 210).

At block 804, where the system is operating in normal mode, market data is received from an exchange (e.g., exchange 130, 230) and where the system is operating in simulation mode, at block 806, recorded market data is provided and received (e.g., from an analytics server, a log, a simulation data store, etc.). The market data feed may have been prerecorded for use in simulation and/or may be recorded as prompted by the simulation. Recorded or otherwise saved market data may be provided as a data stream, snapshot, delta, etc., to the trading system in simulation mode.

At block 808, data is displayed via a trading interface (e.g., such as X-TRADER®, MD TRACER®, etc.) for trader interaction. For example, the recorded market data is provided via a trading interface to display market data and facilitate simulated trade action via the trading system with respect to the recorded market data.

At block 810, trading activity is facilitated via the trading interface. The trading activity may be actual trading activity where the system is in the normal mode or simulated trading activity where the system is in the simulation mode. Real or simulated trade actions are accepted for one or more tradable objects (e.g., arranged in one or more trading algorithms and/or other trading strategy(-ies), etc.). For example, a simulated trade action is implemented for a tradable object with respect to first recorded market data to generate second market data based on an impact of the simulated trade action on the first market data. In an example, where the system is in simulation mode, the trading interface can include a graphical control to adjust a speed to simulated trade action (e.g., slow down and/or speed up passage of time within the simulation/replay, etc.).

At block 812, the operational mode of the system is verified. For example, operation of the system in normal mode versus simulation mode is checked to determine how trading activity is to be processed. Where the system is operating in normal mode, at block 814, the trade action is sent to an exchange (e.g., exchange 130, 230) for processing, execution and/or matching. Where the system is operating in simulation mode, at block 816, the simulated trade action is executed within the simulation. At block 818, a simulation delta resulting from the trade action is determined with respect to the recorded market data in the simulation.

At block 820, an executed trade action (e.g., real or simulated) is logged. Logging or stored trading activity may be flagged or tagged as normal trade activity, simulated trade activity, etc., and normal trade activity may be logged separately from simulated trade activity so as not to invite confusion between actual trading results and simulated trading results. In simulated trading mode, the determined delta may be saved with the trade activity data to enable update of displayed simulation market data and smooth continuation of the trading simulation/replay.

At block 822, the operational mode is again checked. Where the mode is the simulation mode, at block 824, the delta resulting from the simulated trade action is provided as an overlay to be applied to displayed market data via the trading interface.

At block 826, the displayed market data is updated. For example, in simulation mode, an updated market data feed recording is displayed in conjunction with the overlay resulting from the simulation trading delta. In normal mode, an updated market data feed from the exchange is provided. The updated market data is provided for further trade activity via the trading interface at block 810.

Example Replay Simulation System

Rather than providing a separate, manual setup for trading simulation or “back testing” on dedicated on-premise equipment, examples facilitate dynamic, flexible simulation for one or more users in a multi-tenant application service provider (ASP) system. An ASP system may be facilitated regardless of whether the simulation is occurring separately and/or concurrently with “actual” trading activity. Examples provide simulation of custom trading algorithms on a trading system that is easy to configure, easy to execute In an example, a trading system may be arranged to provide systematic back/replay testing of one or more tradable objects (e.g., trading strategies including multiple tradable objects). The system may use standard processes in a trading system stack such as algorithm server, pre-trade risk, credit risk, ledger, and position sever, etc. As configured, the replay system accurately simulates a real market using a replay of recorded or otherwise buffered market data to drive the simulation or “replay”.

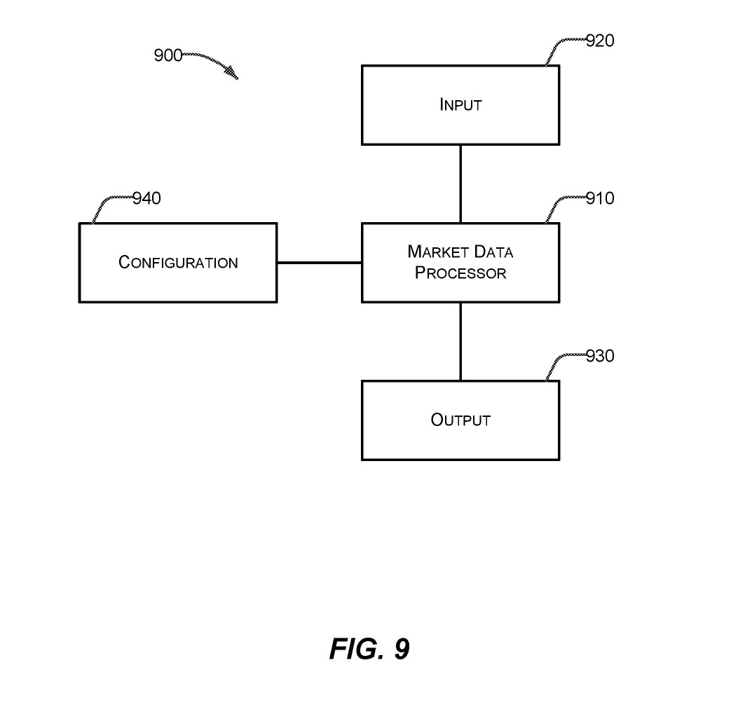

FIG. 9 depicts an exemplary trading system 900 which is configured to provide simulation or replay of recorded and/or other non-live market data as well as execution of trades via an exchange in a “normal” or regular trading mode. The exemplary replay system 900 includes a market data processor 910, input 920, output 930, and configuration 940. The market data processor 910 operates on input data received via the input 920 according to settings, parameters, and/or other instructions provided by the configuration 940. Result(s) of operating on the input data are provided to the output 930.

For example, the configuration 940 indicates an operational mode of the trading system 900. The trading system 900 can operate in a normal trading mode or a simulation mode. Identifying the mode of operation may dictate how the trading system operates. For example, the configuration 940 can specify an image of a production trading system configured in a normal trading mode, simulation mode, etc., to run on a virtual machine using input 920 such as live market data from an exchange, previously recorded market data, analytic input, trading algorithmic input, etc. Live and/or saved market data may be provided as a data stream, snapshot, delta, etc., via input 920 to the trading system 900.

The market data processor 910 facilitates actual and/or simulated trading activity based on the current and/or recorded market data input and one or more trade actions such as trading algorithm(s), other trading strategy(-ies), individual tradable object(s), etc. For example, a simulated trade action is implemented for a tradable object with respect to first recorded market data to generate second market data. The second market data may be generated based on an impact of the simulated trade action on the first market data. In an example, where the system is in simulation mode, the market data processor 910 may adjust a speed to simulated trade action (e.g., slow down and/or speed up passage of time within the simulation/replay, etc.).

A result of a trade action is provided to the output 930 The result may be sent to exchange for processing and execution in a normal trading mode or executed within the simulation by the market data processor 910 in simulation mode. In an example, a delta resulting from the trade action is determined with respect to the recorded market data by the market data processor 910 and provided as output 930.

A log of trade actions and market data movement, whether in normal mode or in simulation, can also be provided as output 930. Logging or stored trading activity may be flagged or tagged as normal trade activity, simulated trade activity, etc., and normal trade activity may be logged separately from simulated trade activity so as not to invite confusion between actual trading results and simulated trading results. In simulated trading mode, the determined delta may be saved with the trade activity data to enable update of displayed simulation market data and smooth continuation of the trading simulation/replay. In an example, the delta resulting from the simulated trade action is provided as an overlay to be applied to displayed market data via a trading interface (e.g., a trading interface associated with the input 920 and/or output 930).

As real or simulated trading activity continues, updated market data may be received as input 920 and processed by the market data processor 910 according to the configuration 940. An updated trading algorithm, other trading strategy, etc., can also be received and processed by the market data processor 910 for real and/or simulated trading. Updates are reflected in a trading interface displayed for trader interaction. In an example, a difference or delta introduced by the simulation may be applied to market data updates to help ensure that simulation trade effects are maintained and/or otherwise propagated during the course of the simulation to more accurately judge trade effects and/or outcomes in the simulation/replay.

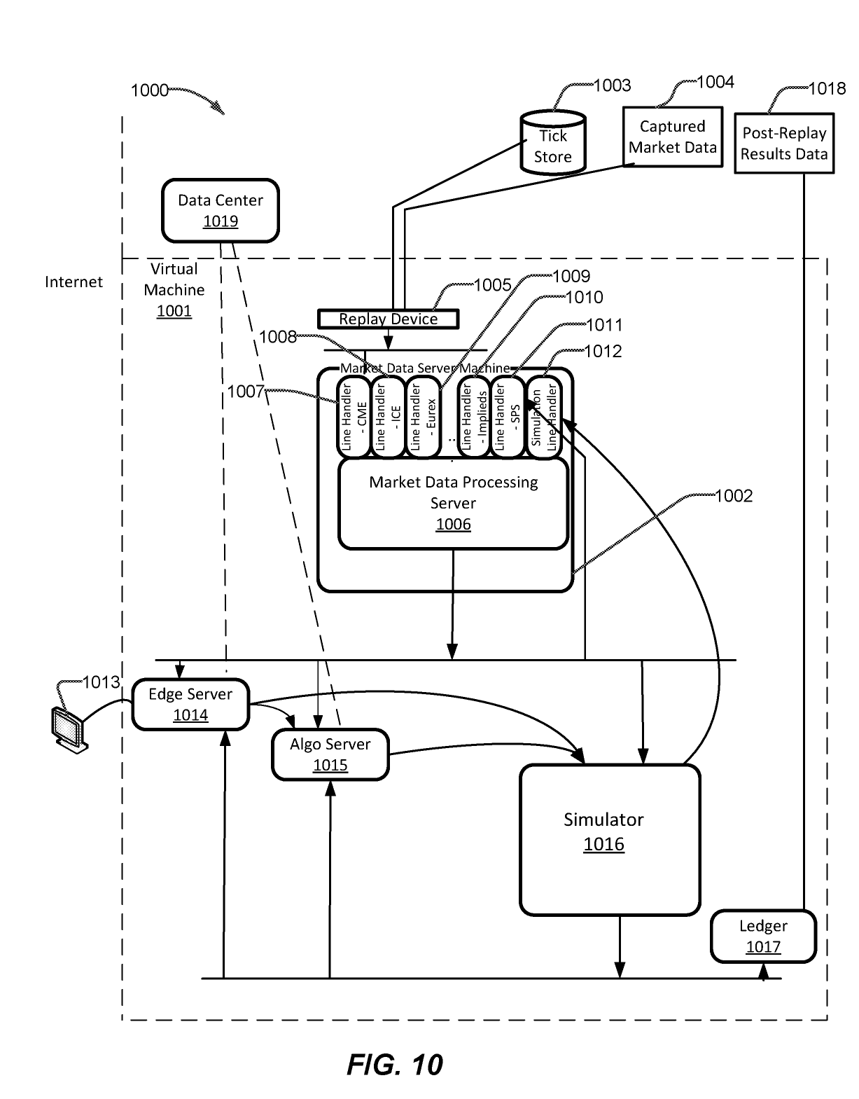

FIG. 10 illustrates an exemplary replay or simulation system 1000 configured from a trading system, such as trading system 210, used in regular trading of tradable objects on an exchange (e.g., exchange 230). As shown in the example of FIG. 10, the replay system 1000 is designed to execute a multiple-piece trading server farm on a single virtual machine (VM) 1001. Components of the replay system 1000 function as they would in normal exchange trading, except for a market data server machine 1002, which is modified to accept replay instructions and replay public market data from a file and/or other market data history source (e.g., market data from a tick store 1003, raw market data capture files 1004, etc., provided to the market data server machine 1002 via a replay device 1005).

In operation, an available VM 1001 may be ordered up, selected, chosen, or otherwise requested from a group of VMs. For example, a plurality of VMs may be running in a public cloud and available. The VM's may be available in various sizes and/or configurations. In an example, the VM's may be offered at an hourly and/or other incremental rate. The identified VM 1001 is exclusive to the requester and an associated market replay for a specified duration and remains running until closed (e.g., by the user, by an end to the specified duration, etc.). In an example, ordering or requesting a VM 1001 for simulation or replay instantiates a replay machine or simulator and triggers a request for recorded market data from one or more sources 1003, 1004 via the replay device 1005. The replay device 1005 may be a software and/or hardware front end to request and format data for the market data processor 1002 when in simulation mode. The market data has been recorded or otherwise saved for a specified duration from a specified or predetermined start time to a specified or predetermined end time.

Once the replay machine 1001 is created, market data is requested and pulled from one or more file or tick database source(s) 1003, 1004. As shown in the example of FIG. 10, the market data server machine 1002 includes a market data processing server 1006 as well as one or more handlers 1007-1012 to accommodate data feeds (e.g., exchanges such as CME, ICE, Eurex, etc.; instruments such as implieds, synthetic instruments, etc.; and simulation trade activity) into the market data processing server 1006. For example, standard instrument price data 1007-1009, implieds data 1010, synthetic instrument data 1011, and simulation/replay feed 1012 handlers translate, format, and/or distribute data to the market data processing server 1006. The market data processing server 1006 may be an image of a production market data processing server 1006 modified to accept replay instructions, The market data processing server 1006 also or alternatively may utilize simulation results and recorded market data 1004 via the replay device 1005 and simulation feed handler 1012.

In an example, level two data is provided for replay/simulation. In response to an amount data being preloaded and buffered, simulation may be initiated. The simulation may be initiated by providing data from the market data processing server 1006 to a simulator 1016. The simulator 1016, may act as an exchange for purposes of the simulation/replay. Trading algorithms and/or other trading strategies may be instantiated, for example, by pointing a trading device 1013 to an address (e.g., an Internet Protocol (IP) address) of the simulator VM 1001 and connecting (e.g., via Web Socket) the trading device 1013 to an edge server 1014 on that virtual machine 1001. The trading device 1013 can also be used to view the replay/simulation via edge server 1014.

For example, the edge server 1014 can communicate with an algo server 1015 to provide one or more trading algorithms and/or other trading strategy to the simulator 1016. The simulator 1016 operates on market data received from the market data processing server 1006 based on the trading algo(s) provided by the algo server 1015. The trading device 1013 may communicate with the edge server 1014 to display results of the trading algorithm working in real time or substantially real time including a processing, memory access, and/or transmission latency delay.

Replay of market data may involve taking buffered or otherwise stored market data for replay and pushing the data out through a market data processing server 1006. The data may be pushed out through the market data processing server 1006 as if the data were actual, real-time market data from an exchange. A replay or simulation driver 1016 uses time synchronization data in conjunction with the market replay data to simulate a market data flow at a correct time offset. For example, where a simulation or replay is of market data buffered from 9:00 am to 4:00 pm and the replay of that buffered market data begins at 1:01:02 pm in the afternoon, events happening at 9:01 am in the market data recording are to be replayed at 1:02:02 pm in the simulation so as to maintain a correct time offset, scale, or relationship.

In an example, a speed of replay may be sped up and/or slowed down, but time relationships within the altered-speed replay are still maintained. For example, where a bid for a tradable object ABC comes thirty (30) minutes before an ask for the tradable object ABC in the buffered market data recording and the replay speed is increased such that one minute of recorded data is replayed in thirty seconds, then the bid for tradable object ABC comes fifteen (15) minutes before the ask for tradable object ABC in the replay simulation. Thus, a trading algorithm or other trading strategy may be replayed at a multiple of real time, rather than at hardcoded times of day.

In operation, the market data being replayed emerges from the market replay data processing server 1006 as standard price multicast data. As part of the replay simulator 1016, the multicast may be received within the VM 1001 only and cannot escape the VM 1001 (e.g., so as not to accidentally reach a real market exchange or other normal trading actor). All subscribing processes receive the multicast of replay market data simultaneously (or at least substantially simultaneously given some transmission, memory access, and/or processing delay). For example, the algo server 1015 and the market simulator 1016 receive the replay market data multicast. Synthetic price feeds based on real market data can feed off the multicast and generate their results for feedback through the market data processing server 1006 in real-time (or substantially real-time given some transmission, memory access, and/or processing delay) without separately recording the synthetic price data. Synthetic price data feed(s) can include structured product (SP) synthetic trading instruments, implied prices, and simulation price feed for private simulation quotes and trades.

In an example, one or more VMs may be configured for a given simulation based on a number of replayed instruments and trading strategies (e.g., algorithms, etc.) to be run. For example, multiple VMs may be set up for a simulation to avoid overloading a single machine 1001 for the replay.

Example Replay System Logistics

In an example, VMs may be implemented using a public or private cloud system (e.g. Amazon Web Services (AWS), vCloud, etc.). The cloud system may have configurable virtual machine options. One or more predefined images may be created in the cloud system. Each image may include an entire system stack, plus a replay-specific driver process. A production trading system stack may be captured in an image (e.g., stored in a data center 1019), and driver(s) for the replay simulation also included in that image. The image may be instantiated in a VM 1001 such that the VM is configured as a production trading system including replay operations (e.g., a delta-based simulation using a recorded market data feed, etc.). The configured VM 1001 also provides accessible storage for level (e.g., level 2, level 3, etc.) market data (e.g., a file-based replay of market data from storage, market data requested instrument by instrument from an analytic server, etc.).

Alternatively or in addition, data may be replayed through an application service provider (ASP) system using new trading instrument names specific to a replay. By providing separate names, replay data may be segregated from real-time data. By switching the trading instruments on orders to match, the actions of trading algorithms in response to the replay data are sent to the trading exchange simulator rather than to real market exchange(s). However, using the ASP approach may negatively impact real market resource availability and performance as well as complicating a provider's ability to charge a user for computing resource usage.

In an example, a replay user may order, select or otherwise request a VM 1001 running in a public cloud. The cloud system may provide the VM, such as via a lease for a period of time. The selected virtual machine 1001 is exclusive to the requesting replay user and the user's replay. The selected VM 1001 remains running until the user closes the VM 1001 or the replay completes. As part of the VM 1001 ordering process, market data from one or more tradable objects may be requested for a time period designated by a start time and an end time.

In response to the replay machine 1001 being created, market data (e.g., level two data) may be requested and pulled in from a tick database source 1003 (e.g., OneTick™, etc.) and/or other recorded data store 1004. Market data may be delivered in chunks of arbitrary size, followed by a done signal. By decoding response timestamps, progress in a requested timespan may be evaluated. In an example, an initial snapshot of market depth is followed by time-stamped delta data specifying changes at price tier levels.

In response to sufficient data being preloaded and buffered, the replay via the simulator 1016 may be initiated. The user can instantiate one or more trading algorithms and/or other trading strategies prior to the start of the replay. The trading algorithms and/or other trading strategies may be instantiated by directed a trading interface 1013 to an address (e.g., an IP address) of the replay VM 1001 and connecting to that VM 1001 at that address (e.g., connecting via Web Socket to an edge server 1001 on the replay VM 1001). The connected trading interface 1013 (e.g., a TT™ via the edge server) can then be used to view the replay including results of the trading algorithm from the algo server 1015 working in real-time (or substantially real-time given some transmission, memory access, and/or processing delay).

### Replay Ordering and Configuration Examples

In an example, a replay may be requested by requesting a replay of one or more trading strategies over a set period time (e.g., from a start of a minute to an end of a minute). A VM (e.g., VM 1001) sufficient to handle a load of replayed trading instruments, trading algorithms, and/or other trading strategies in simulation is selected. In an example, a user interface to order a replay may be implemented as a widget panel in a trading interface (e.g., TT™ window, etc.). Based on a number of trading instruments selected, the interface suggests a virtual machine size to accommodate execution of the simulation replay.

In an example, one or more trading instruments may be selected to be replayed manually. Additionally or alternatively, algos or synthetic spreads may be selected to run (associated instruments then come from their configurations, such as provided by an algo server). Once the replay is requested (and its configuration and pricing are confirmed), representational state transfer (REST) calls and/or other architectural abstraction are used to instantiate the virtual machine (e.g., VM 1001) with the required image in an appropriate datacenter. In the example of FIG. 10, once the VM 1001 is created and an associated IP address is returned, the trading interface on the trading device 1013 can connect to the edge server 1014 on the virtual machine 1001. Via the edge server 1014 and in conjunction with the algo server 1015, the price replay device or simulator 1016 is primed with one or more instruments for trading and an associated time span to replay.

In an example, a trader can control the replay, start, stop, rewind to start, etc., using a special control widget in the trading interface. Users can request speeds faster than real-time for the replay. For more accurate results, trading algos do not use set time delays or elapsed time measurements from a system clock that do not scale the same way as the time speed increase. In addition the speed up replay should not be set to overload the simulation system given the particular trading algos running and number of instruments involved. In an example of FIG. 10, by using process quotas with an operating system of the VM 1001, a “fast as possible” mode may be allowed in simulation, which will run the replay as fast as the market data processing server 1006 and simulator 1016 can operate within their quota, while still allowing processing resource availability for the other components.

In an example, a replay or other simulation can only realistically run at a multiple of a real-time speed before the sender or receivers become overloaded, thereby limiting the number of serial back tests that may be done in a given period. However, to determine a best set of parameters for a trading algo, it may be desirable to run multiple copies of the algorithm each with a different parameter set (e.g., a parallel monte carlo simulation, etc.). Different identifiers may be assigned to different simulations so that each simulation does not interfere with the other, thereby segregating each algorithm's simulated matching and price feedback.

In an example, a trader can configure an average latency for each market center. The average latency can then be implemented as a minimum response latency on an order to acknowledge and quote.

In an example, enduring liquidity reduction is provided. For example, since back-test simulations are of defined and limited duration, a more realistic variant of market simulation provides that, where liquidity is removed from the market, the liquidity remains removed even when price depth is updated. The simulator 1016 maintains a liquidity impairment delta at each price tier for a duration of the replay, which can reduce an effective volume at that tier to zero at minimum. The liquidity impairment delta then represents a most pessimistic view of the simulation's effect on market liquidity, where liquidity removed is never replaced by iceberg orders, or other market participants reacting to trade activity by placing new liquidity into the market(s), etc. For some trading strategies, enduring liquidity reduction may increase accuracy. The simulator 1016 provides the liquidity reduction delta as part of the simulation replay data provided to handler 1012, which translates and distributes the simulation data as with other price updates via the market data processing server 1006.

Additionally, the simulator 1016 can broadcast an execution report. The execution report may be provided to a ledger 1017 to generate an output of post-replay results data 1018 for reporting, auditing, analytics, and/or other feedback. The simulator's 1016 execution report can also be provided to a source such as the algo server 1015 providing trading algorithm(s), other strategy(-ies), etc.

Thus, using the VM 1001 configured with simulator 1016 providing modified data to the market data server machine 1002, coding and selection of trade instrument(s) and/or other tradable object(s) may be tested for validity and likelihood of success based on prior, recorded market data executed in a production trading environment configured for simulation. As simulation execution continues, examples provide a modified simulation price feed which adjusts the recorded market data price feed based on an effect simulation trade activity is having on the recorded market.

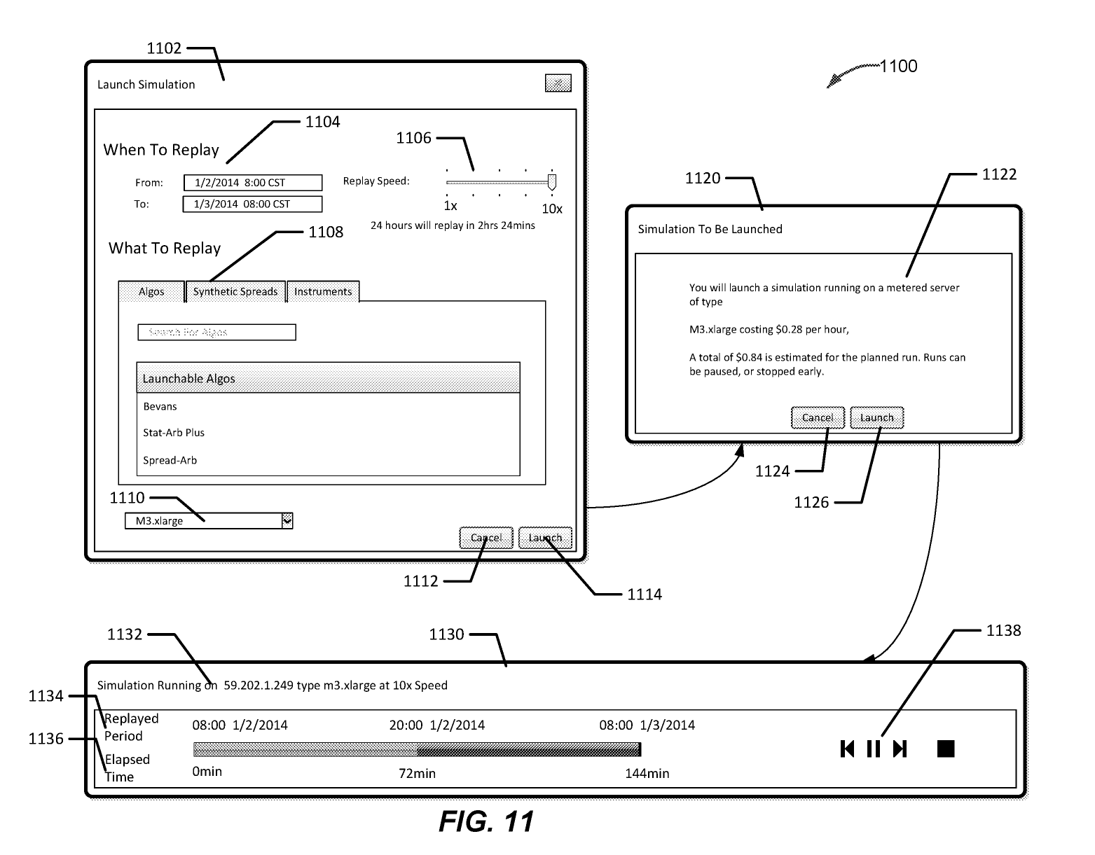

FIG. 11 shows a replay interface 1100 for controlling a replay/simulation. For example, one or more controls may be provided to facilitate movement through a trading simulation such as start, stop, rewind, etc. The replay controls may be provided using a special control widget in a trading interface such as TT™ provided by Trading Technologies. As shown in the example of FIG. 11, a simulation may be initiated via a launch control 1102. The launch control 1102 includes a time period selector 1104 allowing a user to specify a start (e.g., starting date and time) and end (e.g., ending date and time) to the simulation replay period. The launch control 1102 also includes a replay speed selector 1106 which allows the user to set the replay at normal or “real life” speed (e.g., 1×) or at a multiple of real life speed (e.g., at a speed of 10× which replays twenty-four hours in two hours and twenty-four minutes).

The launch control 1102 also allows the user to specify 1108 which instruments, trading strategies (e.g., algos, synthetic spreads, etc.), and/or other tradable objects to replay. For example, via the trading instrument selector 1108, the user selects one or more instruments to be replayed either directly or by selecting spreads and/or trading algorithms to which the user has access and which have configured lists of instruments already associated with them.

FIG. 11 shows the launch control 1102. The launch control may be used to select a server 1110 to execute the replay. In response to configuration options being set for the simulation, the launch control 1102 may facilitate cancellation 1112 or launch 1114 of the replay simulation. In the example of FIG. 11, a confirmation box 1120 is generated via the trading interface to confirm 1122 that the simulation is to run on a metered server. The confirmation box also or alternatively may confirm a cost for an estimated total. The user may cancel 1124 or launch 1126 the simulation. In an example, this confirmation screen 1120 is not displayed. Rather, the simulation is launch upon initiation via 1114 in the primary launch control 1102.

During simulation, a status and control interface 1130 may be provided via the trading interface. The status and control interface 1130 may be positioned adjacent to a trading window in which the trading simulation is executing. Via the status and control interface 1130, configuration information 1132 for the currently running simulation is displayed. Additionally, the total replay period 1134 as well as a currently elapsed time 1136 of the simulation is shown in the example of FIG. 11. Further, one or more replay controls 1138 are provided to allow the user to pause, stop, rewind, fast forward, play, etc., the current simulation.

Example Risk, Audit and Post Replay Analysis

A replay or simulation uses same user credentials and environment as a trader or other user launching the replay. In an example, data is sourced using REST services accessible in the VM machine in the cloud. Examples have limited scope for risk, and pre-trade risk limits may be established.

Audit capability may be provided in the simulation/replay environment, and audit records may be made visible in real-time (or substantially in real-time accounting for some processing, storage/access, and/or transmission delay). Audit records may be stored in external storage for later viewing after the replay has ended. In an example, profit and loss (P&L) tracking is available during the replay and is written to audit at the end as a special record.

In an example, an audit trail that results from SIM trading done during a replay session is recorded in external storage so that the audit trail is visible after the replay has been performed by a special viewer. This viewer allows searching for replays, displaying the data with timestamp adjustment (e.g., a delta of seconds, etc.) to match the time of the market data replayed, etc. In an example, a version of a Ledger process is used to capture data to external storage segmented by user and replay session.

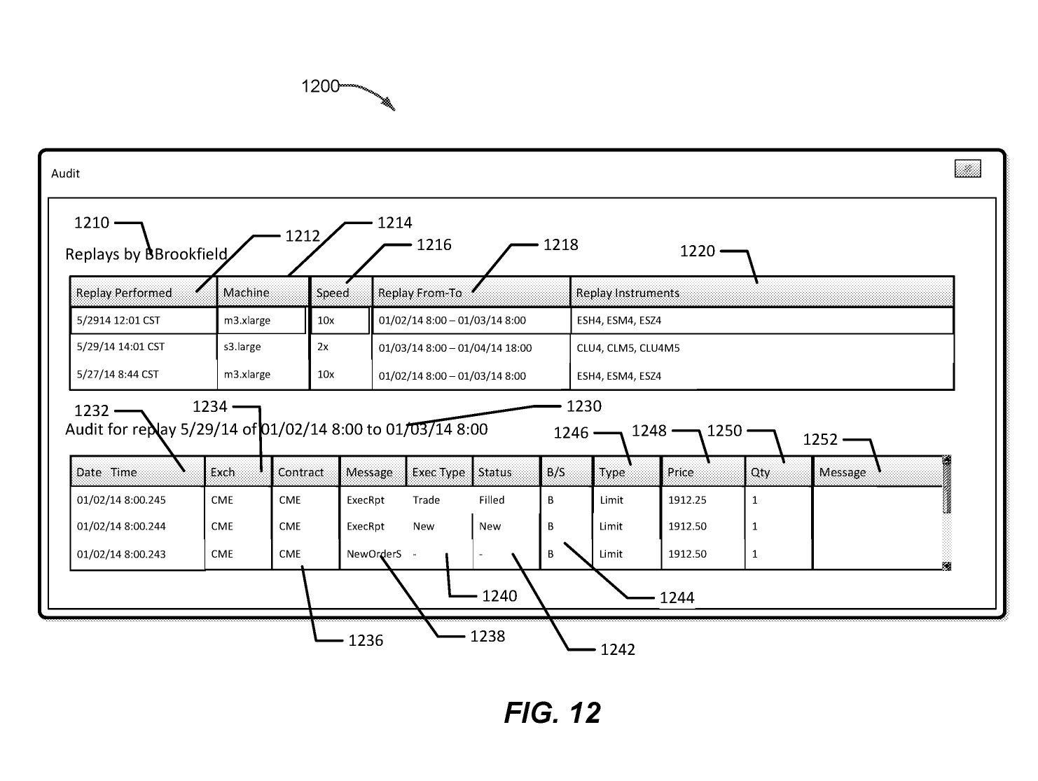

FIG. 12 illustrates an exemplary audit interface 1200 provided in conjunction with replay simulation of one or more trading instruments. The audit interface 1200 includes a listing of replays 1210, such as a listing of replays by user. The available replays 1210 are displayed according to time of replay 1212, machine used for replay 1214, replay speed 1216, replay time period 1218, and instrument(s) involved in the replay simulation 1220.

Audit interface 1200 also provides an audit log 1230 for a selected replay from the list of replays 1210. For the selected replay, the audit log 1230 shows a series of trade actions in the selected replay. As shown in the example of FIG. 12, the audit log 1230 includes a date and time of each trade action by the user, and exchange 1234 and contract 1236 impacted by the trade action. A message 1238 associated with the trade action as well as its execution type 1240 and status 1242 are also provided. Further detail such as well the action is a buy or sell 1244, a type of order 1244 (e.g., a limit order, etc.), a price 1248, and a quantity 1250 are also provided. As shown in the example interface 1200, a message field 1252 is also provided to allow other messages about a trade action to be saved with the audit record. Thus, a reviewer can see the series of available replays, select a replay for further review, and view the audit log of actions which occurred during the replay.

In an example, upon completion of a replay/simulation, the virtual machine providing the simulation is released (e.g., destroyed and/or otherwise freed up for other use). While the simulation results can persist in storage for review and analysis via audit log, P&L affect analysis, etc., the VM vehicle for the simulation does not persist. Simulation data may be stored in a same format and same storage and regular trading data, for example, but should be stored separately so as not to commingle normal and simulation trading data.

Some of the described figures depict example block diagrams, systems, and/or flow diagrams representative of methods that may be used to implement all or part of exemplary embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware. Also, some or all of the exemplary methods may be implemented manually or in combination with the foregoing techniques.

The example block diagrams, systems, and/or flow diagrams may be performed using one or more processors, controllers, and/or other processing devices. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method to provide a simulation on a trading system, the method comprising:
receiving, via an electronic processor, first electronic market data from a stored data source;
receiving via the processor a first simulated trade action for a first tradable object;
executing, via the processor, the first simulated trade action for the first tradable object with respect to the first market data, the execution of the first simulated trade action to generate second market data based on an impact of the first simulated trade action on the first market data;
determining, via the processor, a first delta between the first market data and the second market data, wherein the first delta reflects a difference between the first market data and the second market data;
receiving via the processor a second simulated trade action;
executing via the processor the second simulated trade action with respect to the second market data to generate third market data; and
providing via the processor the third market data for simulated trading.

2. The method of claim 1, wherein the first delta is displayed on a trading interface as an overlay on a market data update received from the stored data source.

3. The method of claim 1, wherein the tradable object comprises a trading algorithm.

4. The method of claim 1, further comprising adjusting a speed of simulated trading based on control input.

5. The method of claim 1, further comprising determining a second delta with respect to the third market data resulting from simulated trading.

6. The method of claim 1, further comprising logging said first delta and said simulated trading.

7. A tangible computer-readable storage medium including instructions that, when executed, cause a computing device to at least implement a simulation on a trading system by:
receiving first market data from a stored data source;
receiving a first simulated trade action for a first tradable object;
executing the first simulated trade action for the first tradable object with respect to the first market data, the execution of the first simulated trade action to generate second market data based on an impact of the first simulated trade action on the first market data;
determining a first delta between the first market data and the second market data, wherein the first delta reflects a difference between the first market data and the second market data;
receiving a second simulated trade action;
executing the second simulated trade action with respect to the second market data to generate third market data; and
providing the third market data for simulated trading.

8. The computer-readable storage medium of claim 7, wherein the instructions cause the computing device to implement the simulation by: displaying the first delta via a trading interface as an overlay on a market data update received from the stored data source.

9. The computer-readable storage medium of claim 7, wherein the instructions cause the computing device to implement the simulation by: adjusting a speed of simulated trading based on control input.

10. The computer-readable storage medium of claim 7, wherein the instructions cause the computing device to implement the simulation by: determining a second delta with respect to the third market data resulting from simulated trading.

11. The computer-readable storage medium of claim 7, wherein the instructions cause the computing device to implement the simulation by: logging said first delta and said simulated trading.
